(19) United States
(12) Patent Application Publication
(10) Pub. No.: US 2025/0232753 A1
(43) Pub. Date: Jul. 17, 2025

(54) ACTIVE ACOUSTIC CONTROL SYSTEMS AND METHODS

(71) Applicant: BAE SYSTEMS PLC, London (GB)

(72) Inventors: Jordan Cheer, Southampton Hampshire (GB); Stephen Daley, Southampton Hampshire (GB); Charles James House, Southampton Hampshire (GB)

(73) Assignee: BAE SYSTEMS PLC, London (GB)

(21) Appl. No.: 18/855,762

(22) PCT Filed: Apr. 6, 2023
(86) PCT No.: PCT/GB2023/050916

§ 371 Date: Oct. 10, 2024

(30) Foreign Application Priority Data
Apr. 11, 2022 (EP) 22275045.7
Apr. 11, 2022 (GB) 2205249.2

(51) Int. Cl. G10K 11/178

(52) U.S. Cl. CPC G10K 11/17821

(57) ABSTRACT

The present disclosure relates to an active acoustic control system comprising: a first sensor arrangement arranged to sense an acoustic signal in the region of an object, the acoustic signal having a scattered acoustic pressure component and a total acoustic pressure, the first sensor arrangement being arranged to sense the total acoustic pressure of the acoustic signal; a processor configured to: apply a filter to filter the total acoustic pressure and provide a filtered output signal; and estimate the scattered acoustic pressure component based on the filtered output signal from the filter; and a control source arrangement operable to control the scattered acoustic pressure component based on the estimation and a regularisation parameter determined based on a relationship between: level of control of the scattered acoustic pressure component of the acoustic signal when controlled using the control source arrangement of the system using a set of test regularisation parameters.

### FIELD

The present invention relates to active acoustic control systems, methods of active acoustic control, a regularisation parameter determination system and a method of determining a regularisation parameter for use in operation of an active acoustic control system.

### BACKGROUND

When an acoustic wave impinges on an object, there is an interaction between the acoustic wave and the object known as “acoustic scattering”. This interaction can take multiple forms. One form is “backscatter”, wherein the acoustic wave is reflected from the object. Another form is “shadowing”, wherein the object blocks the acoustic wave and prevents it from travelling further. Another form is “refraction”, wherein the acoustic wave “bends” around the object. The term “scattered acoustic pressure” includes contributions from all of these forms of interaction.

FIG. 1 is an illustrative schematic of acoustic scattering. In FIG. 1(a), an incident acoustic wave 10, having an incident acoustic pressure, is incident on an object 12. A scattered acoustic wave 14, having a scattered acoustic pressure, is scattered from the object 12. In FIG. 1(b), an acoustic sensor 16 is shown in the soundfield. The acoustic sensor 16 senses the total acoustic pressure 18 in the soundfield, which is a summation of the incident acoustic pressure (of the incident acoustic wave 10) and the scattered acoustic pressure (of the scattered acoustic wave 14) which is scattered from the object 12.

FIG. 2 illustrates acoustic soundfields. FIG. 2(a) illustrates the total acoustic pressure, which is the summation of the incident acoustic pressure component, as shown in FIG. 2(b), and the scattered acoustic pressure component, as shown in FIG. 2(c).

FIG. 3 illustrates generic control of acoustic waves. A primary disturbance source 30 (in this example, in the form of an engine) generates an undesired primary acoustic disturbance signal 32. A control source 34 (in this example, in the form of a loudspeaker) generates a control signal 36. In effective control of the primary disturbance signal to reduce said signal, the primary acoustic disturbance signal 32 and control signal 36 exhibit destructive interference. A small residual signal 38 may remain.

In the present context, the undesired disturbance signal is the scattered acoustic wave 14. It is desirable to control acoustic waves to reduce or minimise the scattered acoustic pressure of the scattered acoustic wave 14. If successfully achieved, the total acoustic pressure 18 will consist only of the incident acoustic pressure component, and, therefore, the presence of the object 12 will have no influence of the soundfield. The object can be described as being “acoustically cloaked”, as it cannot be determined from the total acoustic pressure 18 that an object 12 is present in the soundfield.

In practice, it is not possible to directly measure the incident and scattered components using a single acoustic sensor. Therefore, in order to reduce the scattered acoustic pressure, it is necessary to determine the scattered acoustic pressure.

However, known systems for determining the scattered acoustic pressure have a number of associated problems. Furthermore, known methods of separating the scattered acoustic pressure component from the total acoustic pressure have a number of associated problems. For example, known systems and methods are not able to accurately separate the components, thereby limiting the effectiveness of control of the scattered acoustic pressure. Additionally, complex componentry or experimental setups are required. In some cases, large computational power is required for complex calculations. Other known systems and methods may be operable to control acoustic scattering using a system in a first condition (e.g., having fully operational components), or from an object in a first condition (e.g., size or shape), but do not adequately control acoustic scattering from the object if the condition changes.

Thus, known systems and methods are inadequate.

It is an aim of the present invention to provide an improved system and/or method and/or address one or more problems associated with the prior art discussed above, or discussed elsewhere, or to at least provide an alternative system and/or method.

### SUMMARY

According to an aspect of the present invention, there is provided an active acoustic control system comprising: a first sensor arrangement arranged to sense an acoustic signal in the region of an object, the acoustic signal having a scattered acoustic pressure component and a total acoustic pressure, the first sensor arrangement being arranged to sense the total acoustic pressure; and a processor configured to: apply a first filter to filter the total acoustic pressure and provide a filtered output signal; and estimate the scattered acoustic pressure component based on the filtered output signal from the first filter.

In one example, the processor is configured to estimate the scattered acoustic pressure component for use in control of the scattered acoustic pressure component.

In one example, the first sensor arrangement is arranged to sense an acoustic signal, the acoustic signal having a scattered acoustic pressure component in the far-field of an object and a total acoustic pressure in the near-field of the object, the first sensor arrangement being arranged to sense the total acoustic pressure of the acoustic signal in the near-field of the object; and the processor is configured to: apply a first filter to filter the total acoustic pressure in the near-field of the object and provide a filtered output signal; and estimate the scattered acoustic pressure component in the far-field of the object based on the filtered output signal from the first filter, for use in control of the scattered acoustic pressure component in the far-field of the object.

In one example, the processor is configured to estimate the scattered acoustic pressure component for use in control of the scattered acoustic pressure component in the far-field of the object.

In one example, the system comprises a control source arrangement operable to control the scattered acoustic pressure component based on the estimation of the processor.

In one example, the control source arrangement is operable to control the scattered acoustic pressure component in the far-field of the object based on the estimation of the processor.

In one example, the control source arrangement comprises one or more acoustic control sources and/or structural control sources.

In one example, structural control sources are actuators. In one example, acoustic control sources are microphones.

In one example, the system comprises a second sensor arrangement, the second sensor arrangement being arranged to sense the scattered acoustic pressure of the acoustic signal.

In one example, the second sensor arrangement is arranged to sense the scattered acoustic pressure of the acoustic signal in the far-field of the object. In one example, the processor is configured to calculate the first filter based on a first acoustic transfer response between a primary source and the first sensor arrangement and a second acoustic transfer response between the primary source and the second sensor arrangement.

In one example, the processor is configured to calculate the first filter according to:

$${w}_{opt} = - {[ E [ {R}^{T} ( n ) R ( n ) + β I ] ]}^{- 1} E [ {R}^{T} ( n ) {d}_{s} ( n ) ]$$

where wₒₚₜ is the first filter, R is a matrix of filtered reference signals, I is the identity matrix, dₛ is the scattered acoustic pressure component (or “scattered disturbance signal”), n is the time index, E is the expectation operator, and β is the regularisation parameter.

In one example, the regularisation parameter is chosen to be dependent on the frequency of the acoustic signal or is independent of the frequency of the acoustic signal.

In one example, the first sensor arrangement comprises one or more acoustic sensors and/or structural sensors.

In one example, the second sensor arrangement comprises one or more acoustic sensors and/or structural sensors.

In one example, the acoustic sensors are microphones and/or the structural sensors are accelerometers.

According to a further aspect of the present invention, there is provided a vehicle or structure comprising the active acoustic control system according to the active acoustic control system aspect.

According to a further aspect of the present invention, there is provided a method of active acoustic control comprising: sensing the total acoustic pressure of an acoustic signal in the region of an object, the acoustic signal having a scattered acoustic pressure component and a total acoustic pressure; applying a first filter to filter the total acoustic pressure; providing a filtered output signal; and estimating the scattered acoustic pressure component based on the filtered output signal from the first filter.

In one example, the processor is configured to estimate the scattered acoustic pressure component for use in control of the scattered acoustic pressure component.

In one example, the method comprises sensing the total acoustic pressure of an acoustic signal in the near-field of an object, the acoustic signal having a scattered acoustic pressure component in the far-field of the object and a total acoustic pressure in the near-field of the object; applying a first filter to filter the total acoustic pressure in the near-field of the object; providing a filtered output signal; and estimating the scattered acoustic pressure component in the far-field of the object based on the filtered output signal from the first filter.

In one example, the processor is configured to estimate the scattered acoustic pressure component for use in control of the scattered acoustic pressure component in the far-field of the object.

In one example, the method further comprises a calibration method, the calibration method comprising: sensing a scattered acoustic pressure component of an acoustic signal.

In one example, the calibration method comprises: calculating the first filter based on: a first acoustic transfer response by sensing of the total acoustic pressure of an acoustic signal from a primary source; and a second acoustic transfer response by sensing of the scattered acoustic pressure component of the acoustic signal from the primary source.

In one example, the calibration method comprises: calculating the first filter based on: a first acoustic transfer response by the sensing of the total acoustic pressure of the acoustic signal in the near-field of the object; and a second acoustic transfer response by the sensing of the scattered acoustic pressure component of the acoustic signal in the far-field of the object.

In one example, the method comprises providing a first sensor arrangement.

In one example, the calibration method comprises providing a second sensor arrangement.

In one example, the method comprises, subsequent to performing the calibration method, removing the second sensor arrangement.

According to a further aspect of the present invention, there is provided a regularisation parameter determination system for determining a regularisation parameter for use in operation of an active acoustic control system comprising: a first sensor arrangement arranged to sense an acoustic signal in the region of an object, the acoustic signal having a scattered acoustic pressure component and a total acoustic pressure, the first sensor arrangement being arranged to sense the total acoustic pressure of the acoustic signal; a processor configured to: apply a first filter to filter the total acoustic pressure and provide a filtered output signal; and estimate the scattered acoustic pressure component based on the filtered output signal from the first filter; and a control source arrangement operable to control the scattered acoustic pressure component based on the estimation of the processor and the regularisation parameter, the regularisation parameter determination system comprising: a processor configured to: determine the regularisation parameter based on: a level of control of the scattered acoustic pressure component of the acoustic signal when the acoustic signal is controlled using the control source arrangement of the active control system using a set of test regularisation parameters.

In one example, the active acoustic control system is an active acoustic cloaking system. In one example, the active acoustic cloaking system is for acoustically cloaking an object.

In one example, the active acoustic control system comprises: a first sensor arrangement arranged to sense an acoustic signal, the acoustic signal having a scattered acoustic pressure component in the far-field of an object and a total acoustic pressure in the near-field of the object, the first sensor arrangement being arranged to sense the total acoustic pressure of the acoustic signal in the near-field of the object; a processor configured to: apply a first filter to filter the total acoustic pressure in the near-field of the object and provide a filtered output signal; and estimate the scattered acoustic pressure component in the far-field of the object based on the filtered output signal from the first filter; and a control source arrangement operable to control the scattered acoustic pressure component in the far-field of the object based on the estimation of the processor and the regularisation parameter, and the regularisation parameter determination system comprises: a processor configured to: determine the regularisation parameter based on: a level of control of the scattered acoustic pressure component of the acoustic signal in the far-field of the object when the acoustic signal is controlled using the control source arrangement of the active control system using a set of test regularisation parameters.

In one example, the level of control is a level of attenuation of the scattered acoustic pressure component of the acoustic signal when the acoustic signal is controlled using the control source arrangement of the active control system using a set of test regularisation parameters.

In one example, the processor is configured to: determine the regularisation parameter based on an optimisation of a relationship between: the level of control of the scattered acoustic pressure component of the acoustic signal when the acoustic signal controlled using the control source arrangement of the active control system using the set of test regularisation parameters; and a condition of the active acoustic control system and/or object.

In one example, the processor is configured to, based on a plurality of relationships between a level of attenuation and value of the regularisation parameter, each relationship being for one of a plurality of conditions of the object, select a value of the regularisation parameter corresponding to a peak level of attenuation in an average of the relationships.

In one example, the processor is configured to: determine the regularisation parameter based on an optimisation of a relationship between: the level of control of the scattered acoustic pressure component of the acoustic signal in the far-field of the object when the acoustic signal controlled using the control source arrangement of the active control system using the set of test regularisation parameters.

In one example, the set of test regularisation parameters comprise a range of test regularisation parameters.

In one example, the control source arrangement is operable according to

$${u}_{opt} = - {[ {G}_{0}^{H} {G}_{0} + β I ]}^{- 1} {G}_{0}^{H} {d}_{s 0}$$

where wₒₚₜ is the optimal set of control source strengths of the control source arrangement, G₀ is the nominal matrix of plant responses, I is the identity matrix, dₛ₀ is the nominal scattered acoustic pressure (or “scattered disturbance signal”), and β is the regularisation parameter.

In one example, the regularisation parameter is frequency independent.

In one example, the value of the regularisation parameter is determined to correspond to a peak level of control of the scattered acoustic pressure component of the acoustic signal across a frequency range.

In one example, the regularisation parameter is frequency dependent.

In one example, a set of regularisation parameter values are determined, each value of the set of regularisation parameters being determined to correspond to a peak level of control of the scattered acoustic pressure component of the acoustic signal across at least a subrange of a frequency range.

According to a further aspect of the present invention, there is provided an active acoustic control system comprising: a first sensor arrangement arranged to sense an acoustic signal in the region of an object, the acoustic signal having a scattered pressure and a total acoustic pressure, the first sensor arrangement being arranged to sense the total acoustic pressure of the acoustic signal; a processor configured to: apply a first filter to filter the total acoustic pressure and provide a filtered output signal; and estimate the scattered acoustic pressure component based on the filtered output signal from the first filter; and a control source arrangement operable to control the scattered acoustic pressure component based on the estimation of the processor and a regularisation parameter determined based on a relationship between: a level of control of the scattered acoustic pressure component of the acoustic signal when controlled using the control source arrangement of the active acoustic control system using a set of test regularisation parameters.

In one example, the active acoustic control system is an active acoustic cloaking system. In one example, the active acoustic cloaking system is for acoustically cloaking an object.

In one example, the active acoustic control system comprises: a first sensor arrangement arranged to sense an acoustic signal, the acoustic signal having a scattered acoustic pressure component in the far-field of an object and a total acoustic pressure in the near-field of the object, the first sensor arrangement being arranged to sense the total acoustic pressure of the acoustic signal in the near-field of the object; a processor configured to: apply a first filter to filter the total acoustic pressure in the near-field of the object and provide a filtered output signal; and estimate the scattered acoustic pressure component in the far-field of the object based on the filtered output signal from the first filter; and a control source arrangement operable to control the scattered acoustic pressure component in the far-field of the object based on the estimation of the processor and a regularisation parameter determined based on a relationship between: a level of control of the scattered acoustic pressure component of the acoustic signal when controlled using the control source arrangement of the active control system using a set of test regularisation parameters.

In one example, the level of control is a level of attenuation of the scattered acoustic pressure component of the acoustic signal when controlled using the control source arrangement of the active control system using a set of test regularisation parameters

According to a further aspect of the present invention, there is provided a vehicle or structure comprising a regularisation parameter determination system according to the regularisation parameter determination system aspect or an active acoustic control system according to the active acoustic control system aspect.

According to a further aspect of the present invention, there is provided a method of determining a regularisation parameter for use in operation of an active acoustic control system comprising: a first sensor arrangement arranged to sense an acoustic signal in the region of an object, the acoustic signal having a scattered acoustic pressure component and a total acoustic pressure, the first sensor arrangement being arranged to sense the total acoustic pressure of the acoustic signal; a processor configured to: apply a first filter to filter the total acoustic pressure and provide a filtered output signal; and estimate the scattered acoustic pressure component based on the filtered output signal from the first filter; and a control source arrangement operable to control the scattered acoustic pressure component based on the estimation of the processor and the regularisation parameter, the method comprising: determining the regularisation parameter based on: a level of control of the scattered acoustic pressure component of the acoustic signal when controlled using the control source arrangement of the active acoustic control system using a set of test regularisation parameters.

In one example, the active acoustic control system is an active acoustic cloaking system. In one example, the active acoustic cloaking system is for acoustically cloaking an object.

In one example, the active acoustic control system comprises a first sensor arrangement arranged to sense an acoustic signal, the acoustic signal having a scattered acoustic pressure component in the far-field of an object and a total acoustic pressure in the near-field of the object, the first sensor arrangement being arranged to sense the total acoustic pressure of the acoustic signal in the near-field of the object a processor configured to: apply a first filter to filter the total acoustic pressure in the near-field of the object and provide a filtered output signal; and estimate the scattered acoustic pressure component in the far-field of the object based on the filtered output signal from the first filter; and a control source arrangement operable to control the scattered acoustic pressure component in the far-field of the object based on the estimation of the processor and the regularisation parameter.

In one example, the level of control is a level of attenuation of the scattered acoustic pressure component of the acoustic signal when controlled using the control source arrangement of the active control system using a set of test regularisation parameters.

According to a further aspect of the present invention, there is provided a method of active acoustic control comprising: sensing the total acoustic pressure of an acoustic signal in the region of an object, the acoustic signal having a scattered acoustic pressure component and a total acoustic pressure; applying a first filter to filter the total acoustic pressure; providing a filtered output signal; estimating the scattered acoustic pressure component based on the filtered output signal from the first filter; determining a regularisation parameter based on: a level of control of the scattered acoustic pressure component of the acoustic signal when controlled using the control source arrangement of the active control system using a set of test regularisation parameters; and controlling the scattered acoustic pressure component based on the estimation of the processor and the regularisation parameter.

In one example, the processor is configured to estimate the scattered acoustic pressure component for use in controlling the scattered acoustic pressure component.

In one example, the active acoustic control system is an active acoustic cloaking system. In one example, the active acoustic cloaking system is for acoustically cloaking an object.

In one example, the method comprises sensing the total acoustic pressure of an acoustic signal in the near-field of an object, the acoustic signal having a scattered acoustic pressure component in the far-field of the object and a total acoustic pressure in the near-field of the object; applying a first filter to filter the total acoustic pressure in the near-field of the object; providing a filtered output signal; estimating the scattered acoustic pressure component in the far-field of the object based on the filtered output signal from the first filter, for use in controlling the scattered acoustic pressure component in the far-field of the object; determining a regularisation parameter based on: a level of control of the scattered acoustic pressure component of the acoustic signal when controlled using the control source arrangement of the active control system using a set of test regularisation parameters; and controlling the scattered acoustic pressure component in the far-field of the object based on the estimation of the processor and the regularisation parameter.

In one example, the level of control is a level of attenuation of the scattered acoustic pressure component of the acoustic signal when controlled using the control source arrangement of the active control system using a set of test regularisation parameters.

In one example, the method comprises determining the regularisation parameter based on an optimisation of a relationship between: the level of control of the scattered acoustic pressure component of the acoustic signal when the acoustic signal controlled using the control source arrangement of the active control system using the set of test regularisation parameters; and a condition of the active acoustic control system and/or object.

In one example, the method comprises, based on a plurality of relationships between a level of attenuation and value of the regularisation parameter, each relationship being for one of a plurality of conditions of the object, selecting a value of the regularisation parameter corresponding to a peak level of attenuation in an average of the relationships.

It will of course be appreciated that features described in relation to one aspect of the present invention may be incorporated into the other aspects of the present invention. For example, the method of any aspect of the present invention may incorporate any of the features described with reference to the apparatus of any aspect of the present invention and vice versa.

Other preferred and advantageous features of the invention will be apparent from the following description.

### BRIEF DESCRIPTION OF THE FIGURES

Embodiments of the invention will now be described by way of example only with reference to the figures, in which:

FIG. 1 shows acoustic scattering;

FIG. 2 shows acoustic soundfields;

FIG. 3 shows control of an acoustic signal;

FIG. 4 shows an active acoustic control system;

FIG. 5 shows an active acoustic control system;

FIG. 6 shows a regularisation parameter determination system and an active acoustic control system;

FIG. 7 shows a change in condition of an object;

FIG. 8 shows a change in condition of an object;

FIG. 9 shows plots of the level of control of the acoustic signal against value of the regularisation parameter;

FIG. 10 shows plots of the value of regularisation parameter against frequency;

FIG. 11 shows an active acoustic control system;

FIG. 12 shows a vehicle;

FIG. 13 shows a structure;

FIG. 14 shows general methodology principles;

FIG. 15 shows general methodology principles; and

FIG. 16 shows general methodology principles.

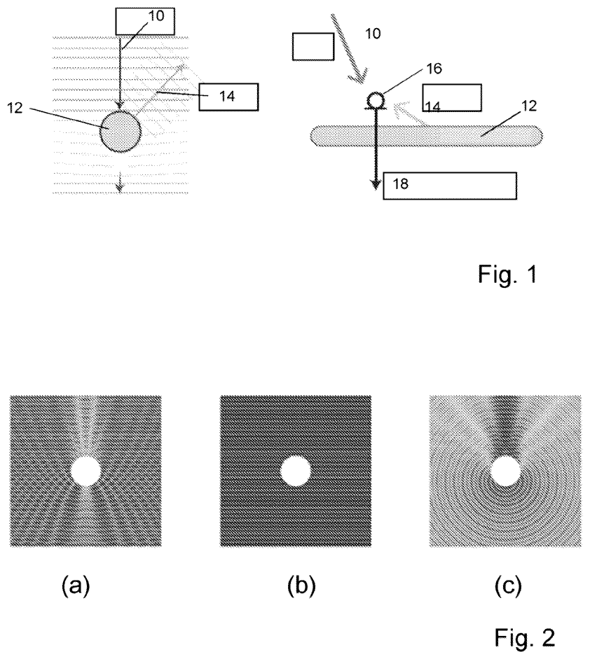

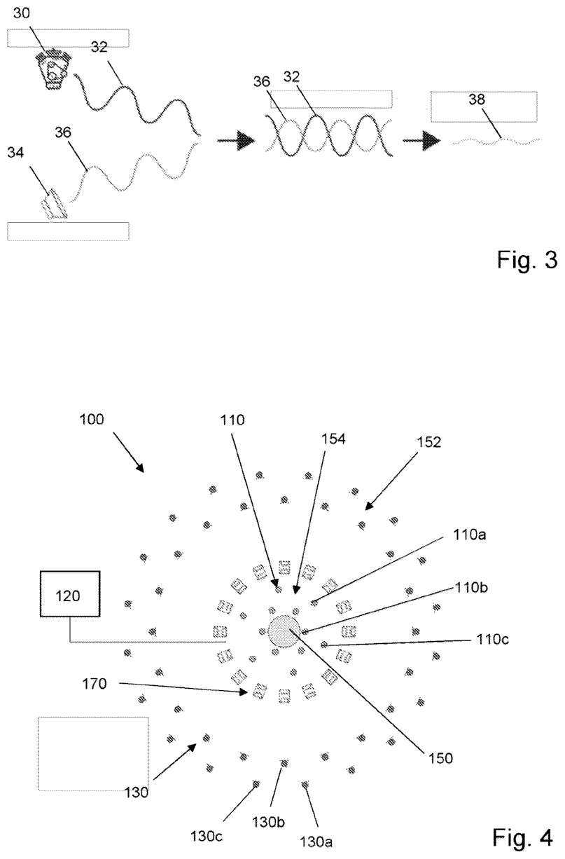

### DETAILED DESCRIPTION

An active acoustic control system 100 and method of active acoustic control are described herein. By this system 100 and method, a scattered acoustic pressure component is accurately estimated based on a filtered output signal. Improved control of the scattered acoustic pressure component is thus facilitated, which has advantages in improving the ability to acoustically cloak an object in a soundfield.

Furthermore, a regularisation parameter determination system 200, active acoustic control system 300 wherein control is performed using a regularisation parameter, and corresponding methods are described herein. By these systems 200, 300 and methods, a regularisation parameter may be determined for use in controlling a scattered acoustic pressure component and used to control a scattered acoustic pressure component. Use of a regularisation parameter allows the systems 200, 300 and methods to be better suited to a particular purpose. For example, a regularisation parameter may be determined and/or used that allows the systems 200, 300 to achieve good control of the scattered acoustic pressure component, but only under certain conditions. In contrast, a regularisation parameter may be determined and/or used that allows the systems 200, 300 and methods to achieve control of the scattered acoustic pressure component under a range of conditions, albeit at a lower level of control. In this way, a “robust” system 200, 300 and method is provided.

Whilst the systems and methods described herein are described as “active acoustic control systems”, it will be understood by the person skilled in the art that performing “control” is not essential to the invention, unless otherwise specified. Indeed, benefits of the invention can be obtained by estimating a scattered acoustic pressure component and/or determining regularisation parameters. By doing so, control (in particular, improved control) can be facilitated, but it is not necessary to perform said control. It may be desired to estimate a scattered acoustic pressure component and/or a regularisation parameter for other purposes, e.g., monitoring of signals or changes in signals, to determine whether control should be performed or adapted.

Furthermore, whilst the systems and methods described herein involve fluidic environments (e.g., liquids and gases), the invention is also applicable to solid environments, for example to control structural vibrations in bodies, components, vehicles and structures.

Referring to FIG. 4, an active acoustic control system 100 is shown. The system 100 comprises a first sensor arrangement 110 arranged to sense an acoustic signal in the region of an object 150. The acoustic signal comprises a scattered acoustic pressure component and a total acoustic pressure. The first sensor arrangement 110 is arranged to sense the total acoustic pressure. The system 100 further comprises a processor 120 configured to apply a first filter to filter the total acoustic pressure and provide a filtered output signal. The processor 120 is configured to estimate the scattered acoustic pressure component based on the filtered output signal from the first filter.

The first sensor arrangement 110 comprises one or more acoustic sensors and/or structural sensors. In this exemplary embodiment, the first sensor arrangement 110 comprises a plurality of acoustic sensors, for example microphones. In another exemplary embodiment, the first sensor arrangement 110 comprises a plurality of structural sensors, for example accelerometers. A structural sensor is configured to sense acoustic signals in structures by, for example, sensing vibration in a body.

The first sensor arrangement 110 comprises a plurality of acoustic sensors 110a, 110b, 110c provided about the object 150 in the near-field. The plurality of acoustic sensors 110a, 110b, 110c are provided in two spaced-apart concentric rings about the object 150 in the near-field.

The components of the acoustic signal relative to the object will be described. The acoustic signal has a scattered acoustic pressure component in the far-field of the object 150. The far-field is indicated generally at 152. The acoustic signal has a total acoustic pressure in the near-field of the object 150. The near-field is indicated generally at 154. The terms “near-field” and “far-field” are well understood in the art. In one example, the near-field is considered to be within two wavelengths of the acoustic wave from the scattering object, and the far-field is in excess of two wavelengths of the acoustic wave from the scattering object. In the description which follows, terms which indicate the location of the component relative to the object (such as “in the far-field of the object”, “in the near-field of the object”, and so on) will be used to improve clarity of description, however this is not intended to imply any limitation to the scope of protection sought.

The acoustic signal may be generated by, for example, a component of a vehicle or structure, such as an engine. Additionally, or alternatively, the acoustic signal may be generated by, for example, an external system operating to emit an acoustic signal with the aim of detecting a vehicle or structure on which the active acoustic control system 100, 300 is provided or at which the method is performed. The external system may monitor for a scattered acoustic pressure component of the emitted acoustic signal. Thus, knowledge of scattered acoustic pressure components of acoustic signals (be they from a generated or emitted acoustic signal) improves the ability to acoustically cloak an object in the soundfield. This may prevent the external system from being able to detect the object, and thus the vehicle or structure.

The processor 120 is configured to apply a first filter to filter the total acoustic pressure in the near-field of the object and provide a filtered output signal. The processor 120 is configured to estimate the scattered acoustic pressure component in the far-field of the object based on the filtered output signal from the first filter. In one example, O opt is the first filter. Other first filters may be used, and will be well understood by those skilled in the art.

In FIG. 4, the active acoustic control system 100 is shown to comprise a first sensor arrangement 110 and a virtual sensor arrangement 130. Virtual sensing is a technique known in the art. For the avoidance of doubt, virtual sensors are not physical sensors. Instead, the term “virtual sensor” is used in relation to the value of the scattered acoustic pressure component at the location of virtual sensors in the virtual sensor arrangement 130. By applying a first filter to filter the total acoustic pressure measured by the first sensor arrangement 110, an estimated value can be determined that is proportional to the scattered acoustic pressure component that would be measured if physical sensors were to be provided at the location of the virtual sensors in the virtual sensor arrangement 130. Thus, it is useful to define the virtual sensor arrangement 130 and refer to locations of virtual sensors in said arrangement 130. The virtual sensor arrangement 130 comprises a plurality of virtual sensors 130a, 130b, 130c provided about the object 150 in the far-field. The plurality of virtual sensors 130a, 130b, 130c are provided in two spaced-apart concentric rings about the object 150 in the far-field.

The first filter allows this estimation of the scattered acoustic pressure component in the far-field of the object to be made based on knowledge of only the total acoustic pressure in the near-field of the object. In this way, it is not necessary to provide a second sensor arrangement in the far-field of the object to sense the scattered acoustic pressure component, as the scattered acoustic pressure component can be estimated as described above. This is highly advantageous as it is not always possible or practical to provide a second sensor arrangement in the far-field of the object. Nevertheless, the scattered acoustic pressure component can still be estimated with high accuracy by applying the first filter to the total acoustic pressure sensed in the near-field of the object.

In this exemplary embodiment, the first filter is a set of filters. The first filter, or set of filters, are linear time-invariant FIR (finite impulse response) filters. The first filter will herein be referred to as a “set of filters”.

The active acoustic control system 100 may be provided with a pre-determined set of filters. These may be calculated by modelling a system, or by testing prior to implementing the system. The set of filters can be calculated for broadband acoustic signals. In one example, this is calculated according to the derivation of wₒₚₜ as described below. This is highly advantageous, as broadband frequency acoustic signals can be suitably controlled by the system 100.

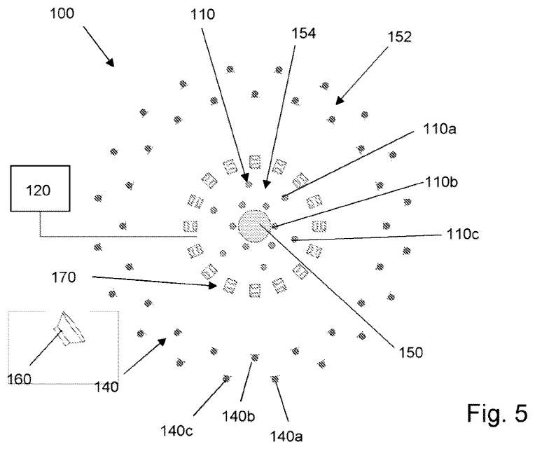

As an alternative to providing the system 100 with a pre-determined set of filters, the active acoustic control system 100 may be calibrated using a calibration method to calculate the set of filters. The calibration method will be introduced with reference to FIG. 5 and comprises the steps of:
providing a second sensor arrangement 140, in addition to the first sensor arrangement 110, wherein the sensors of the second sensor arrangement 140 are located at the locations of the virtual sensors. The second sensor arrangement 140 comprises a plurality of virtual sensors 140a, 140b, 140c provided about the object 150 in the far-field. The plurality of virtual sensors 140a, 140b, 140c are provided in two spaced-apart concentric rings about the object 150 in the far-field. The second sensor arrangement 140 is arranged to sense the scattered acoustic pressure component of the acoustic signal in the far-field of the object. The second sensor arrangement 140 comprises one or more acoustic sensors and/or structural sensors. In this exemplary embodiment, the second sensor arrangement 110 comprises a plurality of acoustic sensors, for example microphones. In this way, acoustic signals in a fluidic environment can be sensed. In another exemplary embodiment, the second sensor arrangement 140 comprises a plurality of structural sensors, for example accelerometers. A structural sensor is configured to sense acoustic signals in structures by, for example, sensing vibration in a body. In this way, acoustic signals in a solid environment can be sensed;
measuring a first acoustic transfer response between a primary source 160 and the first sensor arrangement 110 and a second acoustic transfer response between the primary source 160 and the second sensor arrangement 140;
the processor 120 calculating the set of filters based on the first and second acoustic transfer responses;
optionally adjusting the set of filters by tuning a regularisation parameter (described in greater detail in relation to regularisation parameter determination system 200 and active acoustic control system 300 below); and
removing the second sensor arrangement 140 from the system 100.

Once calibrated, or otherwise provided with a set of filters, the system 100 is used to sense the total acoustic pressure in the near-field of the object using the first sensor arrangement 110, and the set of filters are applied by the processor 120 to the output of the first sensor arrangement 110 to provide a filtered output signal. The processor 120 estimates the scattered acoustic pressure component of the acoustic signal based on the filtered output signal from the first filter.

In this way, the system 100 may be referred to as a calibrated system. The only physical sensors that are required are those of the first sensor arrangement 110. This is because the first filters have been calculated, or have been provided to the system 100, such that they can be used by the system 100 to estimate the scattered acoustic pressure component. The scattered acoustic pressure component is estimated at the location of the virtual sensor arrangement 130.

In greater detail, the set of filters can be calculated and provided to, or by, the system 100. The set of filters may be referred to as a set of “control filters”. Whilst this will be described in relation to the setup of FIG. 5, it will be understood that the calculation of the optimal observation filters is not dependent on a specific arrangement of sensors. The set of filters are calculated as follows: The scattered acoustic pressure measured at the I-th sensor of the second sensor arrangement after control can be expressed at the n-th time step as

$${e}_{{s}_{l}} ( n ) = {d}_{{s}_{l}} ( n ) + {\sum }_{m = 1}^{M} {\sum }_{j = 0}^{J - 1} {\sum }_{k = 1}^{K} {\sum }_{i = 0}^{I - 1} {g}_{lmj} {w}_{mki} {x}_{k} ( n - i - j ) , \qquad ( 4.1 )$$

where dₛ_{ₜ}(n) is the scattered pressure at the l-th error sensor due to the primary disturbance, gₗₘⱼ is the j-th coefficient of the J-th order FIR filter approximating the plant response between the m-th control source and the l-th error sensor, wₘₖᵢ is the i-th coefficient of the l-th order FIR control filter corresponding to the m-th control source and the k-th reference signal, and xₖ is the k-th reference signal. By assuming the controller is time invariant, Equation 4.1 can be rewritten as

$${e}_{{s}_{l}} ( n ) = {d}_{{s}_{l}} ( n ) + {\sum }_{m = 1}^{M} {\sum }_{k = 1}^{K} {\sum }_{i = 0}^{I - 1} {w}_{mki} {r}_{lmk} ( n - i ) , \qquad ( 4.2 )$$

where rₗₘₖ is the k-th reference signal filtered by the plant response between the m-th control source and the l-th error microphone. The filtered reference signal can be expressed as

$${r}_{lmk} ( n ) = {\sum }_{j = 0}^{J - 1} {g}_{lmj} {x}_{k} ( n - j ) . \qquad ( 4.3 )$$

For convenience, Equation 4.2 can be expressed in vector form as

$${e}_{{s}_{l}} ( n ) = {d}_{{s}_{l}} ( n ) + {\sum }_{i = 0}^{l - 1} {w}_{i}^{T} {r}_{l} ( n - i ) , \qquad ( 4.4 )$$

where wᵢ and rᵢ(n) are defined as

$${w}_{i} = {[ {w}_{11 i} , {w}_{12 i} , … , {w}_{1 Ki} , {w}_{21 i} , … {w}_{MKi} ]}^{T} \qquad ( 4.5 )$$

$${r}_{l} ( n ) = {[ {r}_{l 11} ( n ) , {r}_{l 12} ( n ) , … , {r}_{l 1 K} ( n ) , {r}_{l 21} ( n ) , … , {r}_{lMK} ( n ) ]}^{T} . \qquad ( 4.6 )$$

The multichannel control problem can then be formulated by expressing the vector of L error signals in the time domain as

$${e}_{s} ( n ) = {d}_{s} ( n ) + R ( n ) w , \qquad ( 4.7 )$$

$$where$$

$${e}_{s} ( n ) = {[ {e}_{{s}_{i}} ( n ) , … , {e}_{{s}_{L}} ( n ) ]}^{T} , \qquad ( 4.8 )$$

$${d}_{s} ( n ) = {[ {d}_{{s}_{i}} ( n ) , … , {d}_{{s}_{L}} ( n ) ]}^{T} , \qquad ( 4.9 )$$

$$R ( n ) = [ \begin{matrix}{{r}_{1} ( n )}^{T} & {{r}_{1} ( n - 1 )}^{T} & … & {{r}_{1} ( n - I + 1 )}^{T} \\ {r}_{2} {( n )}^{T} & {{r}_{2} ( n - 1 )}^{T} & … & {{r}_{2} ( n - I + 1 )}^{T} \\ ⋮ & ⋮ & & ⋮ \\ {r}_{L} {( n )}^{T} & {{r}_{L} ( n - 1 )}^{T} & … & {{r}_{L} ( n - I + 1 )}^{T}\end{matrix} ] , \qquad ( 4.1 )$$

and the MKI vector of control filter coefficients is defined as

$$w = {[ {w}_{0}^{T} , {w}_{1}^{T} … {w}_{I - 1}^{T} ]}^{T} . \qquad ( 4.11 )$$

The cost function, in the context of acoustic cloaking, is defined as

$$J = E [ {{e}_{s} ( n )}^{H} {e}_{s} ( n ) + β {w}^{H} w ] , \qquad ( 4.12 )$$

where β is the regularisation parameter, a positive real effort-weighting parameter to constrain the magnitude of the source strengths. Substituting Equation 4.7 into Equation 4.12 gives the quadratic cost function as

$$J = {w}^{T} E [ {R}^{T} ( n ) R ( n ) + β {w}^{H} w ] w + 2 {w}^{T} E [ {R}^{T} ( n ) {d}_{s} ( n ) ] + E [ {d}_{s}^{T} ( n ) {d}_{s} ( n ) ] . \qquad ( 4.13 )$$

Assuming that E[R^{T}(n)R(n)] is positive definite, this cost function has a unique global minimum and the optimal set of control filters that minimises the scattered acoustic field at the error sensors is given as

$${w}_{opt} = - {[ E [ {R}^{T} ( n ) R ( n ) + β I ] ]}^{- 1} E [ {R}^{T} ( n ) {d}_{s} ( n ) ] . \qquad ( 4.14 )$$

For avoidance of doubt, in Equation 4.14, wₒₚₜ is the first filter (or “optimal set of control filters), R is a matrix of filtered reference signals, I is the identity matrix, dₛ is the scattered acoustic pressure component (or “scattered disturbance signal”), n is the time index, E is the expectation operator, and β is the regularisation parameter. Tikhonov regularisation has been included into Equation 4.14 to introduce a constraint on the control effort and to improve the conditioning of the matrix inversion, via the regularisation parameter β.

Determination of the regularisation parameter is described in further detail below in relation to the regularisation parameter determination system 200 and active acoustic control system 300.

In the present system 100, the regularisation parameter may be based on: a level of control of the scattered acoustic pressure component of the acoustic signal when the acoustic signal is controlled using the control source arrangement of the active acoustic control system using a set of test regularisation parameters. This may be referred to as “tuning” the regularisation parameter.

In this exemplary embodiment, the regularisation parameter is chosen to be independent of the frequency of the acoustic signal. That is, a single regularisation parameter is chosen which is used to control the acoustic signal irrespective of frequency. However, in another exemplary embodiment, the regularisation parameter is chosen to be dependent on the frequency of the acoustic signal. In this way, the level of control of the acoustic signal over a broadband may be improved. Determination of frequency independent and dependent regularisation parameters is described in further detail below in relation to the regularisation parameter determination system 200 and active acoustic control system 300.

In greater detail, the set of filters can be calculated and provided to, or by, the system 100. The set of filters may be referred to as a set of “observation filters”. Whilst this will be described in relation to the setup of FIG. 5, it will be understood that the calculation of the optimal observation filters is not dependent on a specific arrangement of sensors.

Referring to FIG. 5, the setup comprises a first sensor arrangement 110 in the near-field and a second sensor arrangement 140 in the far-field. dₘ is the vector of total acoustic pressure at the acoustic sensors of the first sensor arrangement 110. dₑ is the vector of scatted acoustic pressure at the acoustic sensors of the second sensor arrangement 140. O is the matrix, or set, of observation filters. \hat{d}ₑ is the vector of estimated scattered acoustic pressures at the second sensor arrangement 140 positions. ∈ is the vector of estimation errors.

The far-field second sensor arrangement 140 of Nₑ sensors forms the virtual sensors, whilst the near-field first sensor arrangement 110 of Nₘ measurements of the total acoustic pressure forms so-called “measurement sensors”. A matrix of observation filters O will be calculated such that signals from the measurement sensors, when filtered by the observation filters, give an estimate of the signals at the virtual sensors.

The JNₑ×1 vector of current and past disturbance signals at the virtual sensors, dₑ(n), and the JNₘ×1 vector of current and past disturbance signals at the measurement sensors, dₘ(n), are defined as

$${d}_{e} ( n ) = {[ {d}_{{e}_{1}}^{T} ( n ) , {d}_{{e}_{2}}^{T} ( n ) … {d}_{{e}_{{N}_{e}}}^{T} ( n ) ]}^{T} \qquad ( 5.1 )$$

$${d}_{m} ( n ) = {[ {d}_{{m}_{1}}^{T} ( n ) , {d}_{{m}_{2}}^{T} ( n ) … {d}_{{m}_{{N}_{m}}}^{T} ( n ) ]}^{T} , \qquad ( 5.2 )$$

$$where$$

$${d}_{{e}_{{u}_{e}}} ( n ) = {[ {d}_{{e}_{{u}_{e}}} ( n ) , {d}_{{e}_{{u}_{e}}} ( n - 1 ) … {d}_{{e}_{{u}_{e}}} ( n - J - 1 ) ]}^{T} \qquad ( 5.3 )$$

$${d}_{{m}_{{u}_{m}}} ( n ) = {[ {d}_{{m}_{{u}_{m}}} ( n ) , {d}_{{m}_{{u}_{m}}} ( n - 1 ) … {d}_{{m}_{{u}_{m}}} ( n - J - 1 ) ]}^{T} . \qquad ( 5.4 )$$

According to the virtual sensing strategy, the JNₑ×1 vector of estimated current and past disturbance signals at the virtual sensors, \hat{d}ₑ(n), is given by filtering the measurement sensor signals, dₘ, as

$$( n ) = {Od}_{m} ( n ) , \qquad ( 5.5 )$$

where O is the matrix of observation filter coefficients, defined as

$$O = {[ {O}_{1}^{T} , {O}_{2}^{T} … {O}_{{N}_{e}}^{T} ]}^{T} , \qquad ( 5.6 )$$

$$where$$

$${O}_{{n}_{e}} = {[ {O}_{{n}_{e} 1}^{T} , {O}_{{n}_{e} 2}^{T} … {O}_{{n}_{e} {N}_{m}}^{T} ]}^{T} , \qquad ( 5.7 )$$

and Oₙ_{ₑ}ₙ_{ₘ} is the observation filter between the nₘth measurement microphone and the nₑth virtual microphone, modelled by a Jth order FIT filter given as

$${O}_{{n}_{e} {n}_{m}} = {[ {O}_{{n}_{e} {n}_{m} 0} , {O}_{{n}_{e} {n}_{m} 1} ⋯ {O}_{{n}_{e} {n}_{m} ( J - 1 )} ]}^{T} . \qquad ( 5.8 )$$

The estimation error, ∈, is defined as the difference between the disturbance signals measured at the virtual sensors, dₑ, and the estimated signals at these locations, \hat{d}ₑ, which gives

$$ϵ ( n ) = {d}_{e} ( n ) - ( n ) . \qquad ( 5.9 )$$

Substituting Equation 5.5 into Equation 5.9 gives the estimation error as

$$\text{?} ( n ) = {d}_{e} ( n ) - Od \text{?} ( n ) . \qquad ( 5.1 )$$

$$\text{?} \text{indicates text missing or illegible when filed}$$

The matrix of optimal observation filters, Oₒₚₜ, can then be found by minimising the sum of the squared estimation errors and, therefore, the cost function, J, can be expressed as

$$J = trace [ E [ \text{?} ( n ) \text{?} {( n )}^{T} + {β}_{est} {OO}^{T} ] ] \qquad ( 5.11 )$$

$$\text{?} \text{indicates text missing or illegible when filed}$$

where βₑₛₜOO^{T} is included to constrain the magnitude of the observation filters. By combining Equations 5.10 and 5.11, the cost function can be expressed as

$$J = trace [ E [ {d}_{e} ( n ) - {Od}_{m} ( n ) ) {( {d}_{e} ( n ) - {Od}_{m} ( n ) )}^{T} + {β}_{est} {OO}^{T} ] ] . \qquad ( 5.12 )$$

The cost function given in Equation 5.12 can be minimised in a manner well understood by those skilled in the art, for example as described in Signal Processing for Active Control; Stephen J. Elliot; ISBN 0-12-237085-6, giving the optimal matrix of observation filters (i.e., the set of filters), Oₒₚₜ, as

$${O}_{opt} = {( {[ E [ {d}_{m} ( n ) {d}_{m}^{T} ( n ) + {β}_{est} I ] ]}^{- 1} E [ {d}_{m} ( n ) {d}_{m}^{T} ( n ) ] )}^{T} \qquad ( 5.13 )$$

The solution of Equation 5.13 is an engineering approximation, and, therefore, the minimum mean square error that can be achieved by the virtual sensing technique may be non-zero. As described in further detail herein, the observation filters can be calculated in an initial setup phase, according to Equation 5.13. Subsequently, a far-field sensor array is no longer required and the virtual sensing method can be used to estimate the far-field scattered acoustic pressure.

Once the set of filters have been calculated by, or provided to, the system 100, no second sensor arrangement 140 is necessary. That is, where the system 100 was provided with a second sensor arrangement 140 for performing a calibration method to calculate the set of filters, the second sensor arrangement can be removed. In other words, subsequent to performing the calibration method, the method comprises removing the second sensor arrangement 140. Thereon, the only physical sensors that are required are those of the first sensor arrangement 110. This is because the first filters have been calculated, or have been provided to the system 100, such that they can be used by the system 100 to estimate the scattered acoustic pressure component.

In operation of the system 100, an acoustic signal incident on the object 150 is scattered therefrom. The acoustic signal has a scattered acoustic pressure component in the far-field and a total acoustic pressure in the near-field. The first sensor arrangement 110 senses the total acoustic pressure. The processor 120 is connected to, and receives an input from, the first sensor arrangement 110. The first sensor arrangement 110 provides information of the total acoustic pressure to the processor 120. The processor 120 applies the set of filters to filter the total acoustic pressure and provide a filtered output signal. The processor 120 estimates the scattered acoustic pressure component based on the filtered output signal from, or by using, the first filter. Ultimately, the scattered acoustic pressure component may be proportional to, or indicated by, the filtered output signal.

The system 100 further comprises a control source arrangement 170. The control source arrangement 170 is operable to control the scattered acoustic pressure component based on the estimation of the processor 120.

The control source arrangement 170 comprises one or more acoustic control sources and/or structural control sources. In this exemplary embodiment, the control source arrangement 170 comprises a plurality of acoustic control sources, for example loudspeakers. In this way, acoustic signals in a fluidic environment can be controlled. In another exemplary embodiment, the control source arrangement 170 comprises a plurality of structural control sources, for example actuators. A structural control source is configured to control acoustic signals in structures by, for example, generating vibration in a body. In this way, acoustic signals in a solid environment can be controlled.

In this exemplary embodiment, the plurality of acoustic control sources of the control source arrangement 170 are provided in a ring about the object 150. The ring of control sources is farther from the object 150 than the first sensor arrangement 110. The ring of control sources is closer to the object 150 than the second sensor arrangement 140, when said arrangement 140 is provided in the system 100.

The control source arrangement 170 is arranged to receive input from the processor 120. The control source arrangement 170 is connected to the processor 120. The processor provides the estimation of the scattered acoustic pressure component to the control source arrangement 170. Upon receiving said estimation of the scattered acoustic pressure component, the control source arrangement 170 operates to generate a control signal to reduce the scattered acoustic pressure component. This is achieved by the control source arrangement 170 generating a control signal which destructively interferes with the scattered acoustic pressure component of the acoustic signal. In this way, the object can be acoustically cloaked. That is, the presence of the object cannot be determined from the soundfield.

In summary, an active control system 100 and method of active acoustic control has been described. The system and method facilitate acoustic cloaking of an object in a soundfield.

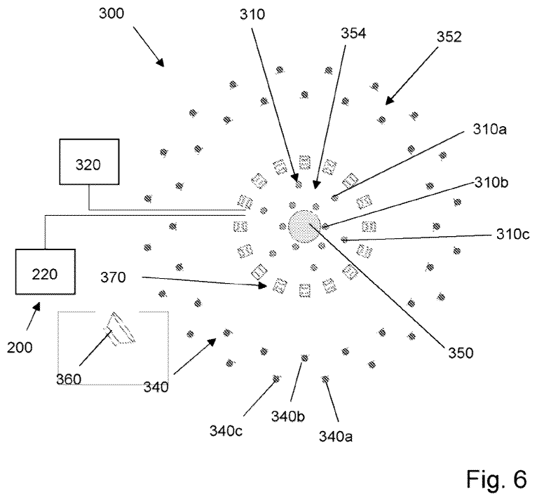

Referring to FIG. 6, a regularisation parameter determination system 200 for determining a regularisation parameter for use in operation of an active acoustic control system 300 is shown. The active acoustic control system 300 may incorporate some or all of the features of the active acoustic control system 100 as described above.

The active acoustic control system 300 comprises a first sensor arrangement 310 arranged to sense an acoustic signal in the region of an object 350. The acoustic signal comprises a scattered acoustic pressure component and a total acoustic pressure. The first sensor arrangement 310 is arranged to sense the total acoustic pressure of the acoustic signal. The system 300 further comprises a processor 320 configured to apply a first filter to filter the total acoustic pressure and provide a filtered output signal. The processor 320 is configured to estimate the scattered acoustic pressure component based on the filtered output signal from the first filter. The system 300 further comprises a control source arrangement 370 operable to control the scattered acoustic pressure component based on the estimation of the processor 320 and the regularisation parameter.

The regularisation parameter determination system 200 comprises a processor 220 configured to determine the regularisation parameter based on a level of control of the scattered acoustic pressure component of the acoustic signal when the acoustic signal is controlled using the control source arrangement 370 of the active acoustic control system 300 using a set of test regularisation parameters.

Determining a regularisation parameter is highly advantageous. A regularisation parameter can allow for robustness in operation of the active control system 300. In this way, uncertainties in the estimation of the scattered pressure can be accounted for, and the system 300 can be operated accordingly. There are many ways in which uncertainty may be inadvertently introduced into the system. One factor is the presence of electromagnetic noise in the system 300, and, in particular, electromagnetic noise in the sensed signal provided by the first sensor arrangement 310. Another factor is perturbation in the position or size of the object 350 from which the acoustic signal is scattered. The impact of temperature, pressure, or degradation of the object or connecting components, may cause perturbation in the position or size of the object 350. However, in some situations it is important that the system 300 functions effectively despite the uncertainty.

As above, the components of the acoustic signal relative to the object will be described. The acoustic signal has a scattered acoustic pressure component in the far-field of the object 350. The far-field is indicated generally at 352. The acoustic signal has a total acoustic pressure in the near-field of the object 350. The near-field is indicated generally at 354. The terms “near-field” and “far-field” are well understood in the art. In one example, the near-field is considered to be within two wavelengths of the acoustic wave from the scattering object, and the far-field is in excess of two wavelengths of the acoustic wave from the scattering object. In the description which follows, terms which indicate the location of the component relative to the object (such as “in the far-field of the object”, “in the near-field of the object”, and so on) will be used to improve clarity of description, however this is not intended to imply any limitation to the scope of protection sought.

The acoustic signal may be generated by, for example, a component of a vehicle or structure, such as an engine. Additionally, or alternatively, the acoustic signal may be generated by, for example, an external system operating to emit an acoustic signal with the aim of detecting a vehicle or structure on which the active acoustic control system 300 is provided or at which the method is performed. The external system may monitor for a scattered acoustic pressure component of the emitted acoustic signal. Thus, knowledge of scattered acoustic pressure components of acoustic signals (be they from a generated or emitted acoustic signal) improves the ability to acoustically cloak an object in the soundfield. This may prevent the external system from being able to detect the object, and thus the vehicle or structure. Furthermore, determining a regularisation parameter allows the active acoustic control system 300 to operate using the regularisation parameter. The ability to acoustically cloak the object 350 is therefore maintained despite changes in condition of the active acoustic control system 300 and/or object 350.

In other words, if the condition of the object 350 is changed, for example due to the impact of temperature, pressure, or degradation of the object or connecting components (as described previously), the active acoustic control system 300 remains able to acoustically cloak the object 350. This may be at a lower level of control, or attenuation, of the acoustic signal. However, the acoustic control may still be at a sufficient level to prevent the external system being able to detect the object 350. The regularisation parameter thus accounts for a level of uncertainty in the position or shape/size (or other appropriate condition) of the object.

Despite this, determining a regularisation parameter based on the condition of the object is not known in the prior art. In prior art approaches, a regularisation parameter may be chosen for an object at a particular point in time (without considering the condition of the object, or the performance of the system given changes (e.g., expected or predicted changes) of the object). In said prior art approaches, regularisation is used to resolve matrix conditioning issues, which can occur due to many numerical and physical factors. However, said matrix conditioning issues are distinct from the issues addressed by the present approach to determination of the regularisation parameter, which considers variation or uncertainty in the system responses. Furthermore, in said prior art approaches which use regularisation to resolve matrix conditioning problems, only a single system configuration need be considered, whereas in the present approach the system (in particular, the object) is considered under various conditions in order to determine or select the regularisation parameter. That is, prior art approaches do not determine a regularisation parameter with consideration of a plurality of conditions of the active acoustic control system and/or object Furthermore, such prior art systems do not facilitate effective acoustic cloaking if a condition of the object were to change, or do not account for any level of uncertainty in the condition of the object.

Selection of the regularisation parameter based on uncertainties in the condition of the object (e.g., position, size, etc., of the object) is highlight advantageous in an acoustic cloaking implementation. The regularisation parameter determination system 200 may form part of an active acoustic control system 100, which may be an active acoustic cloaking system.

In an example of a known system, the condition of the object may be monitored in real-time and the controller updated accordingly. However, this is not a viable approach where real-time monitoring is not possible, and furthermore real-time monitoring may require high processing power, may be complex, or expensive.

Highly advantageously, by determining the regularisation parameter based on the object condition, as opposed to real-time monitoring and updating the controller operation, is that the implementation is more efficient. Specifically, determining the regularisation parameter in the present manner does not require additional sensing and adaptive processing to select controller operation depending on object condition.

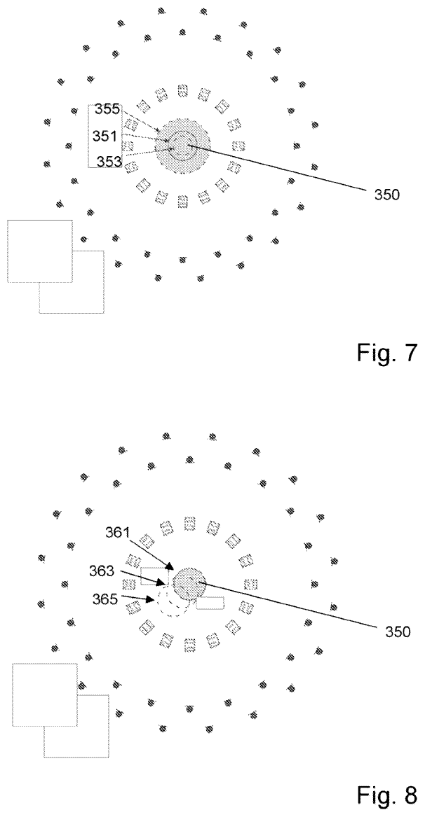

Referring to FIG. 7, a change in condition of the object 350 is shown. Perturbation of the size of the object 350 is illustrated. A nominal size is indicated at 351. A first perturbed size is indicated at 353. A second perturbed size is indicated at 355. Control of the scattered acoustic pressure component can still be achieved despite the perturbation in size of the object 350 by using a regularisation parameter as described herein.

Referring to FIG. 8, a change in condition of the object 350 is shown. Perturbation of the position of the object 350 is illustrated. A nominal position of the object is indicated at 361. A first perturbed position is indicated at 363. A second perturbed position is indicated at 365. Control of the scattered acoustic pressure component can still be achieved despite the perturbation in position of the object 350 by using a regularisation parameter as described herein.

Referring back to FIG. 6, the processor 320 is configured to apply a first filter to filter the total acoustic pressure in the near-field of the object and provide a filtered output signal. The processor 320 is configured to estimate the scattered acoustic pressure component in the far-field of the object based on the filtered output signal from the first filter. This is performed as described above in relation to the active acoustic control system 100.

As introduced above, the processor 220 is configured to determine the regularisation parameter based on a level of control of the scattered acoustic pressure component of the acoustic signal in the near-field of the object when the acoustic signal is controlled using the control source arrangement of the active acoustic control system using a set of test regularisation parameters. This will be described in further detail herein.

In a first step, transfer responses between a far-field primary source 360 and the first sensor arrangement 310 are measured with and without the object 350 being present. In other words, the processor 220 is configured to calculate a vector of acoustic scattered pressure based on the difference between: a first acoustic transfer response of a sensor to a first acoustic signal; and a second acoustic transfer response of a sensor to a second acoustic signal with an object interacting with the acoustic signal. The difference between these transfer responses gives a vector of acoustic scattered pressure, dₛ, calculated at each first sensor location.

Next, transfer responses between the control source arrangement 370 and a second sensor arrangement 340 provided in the far-field are measured. The second sensor arrangement 340 is identical to the second sensor arrangement 130 described above. These measurements of transfer responses forms a matrix of acoustic plant responses, G. In other words, the processor 220 is configured to calculate a plant response between the control source arrangement 370 and the second sensor arrangement 340.

Next, an uncertainty value is introduced into the calculated scattered acoustic pressure component dₛ and calculated plant response G. In other words, the processor 220 is configured to introduce an uncertainty value into the calculated scattered acoustic pressure component and the calculated plant response, according to

$$d \text{?} = {d}_{{s}_{0}} + Δ {d}_{s} \text{?} \qquad ( 3.1 )$$

$$G = {G}_{0} + Δ G \text{?} \qquad ( 3.2 )$$

$$\text{?} \text{indicates text missing or illegible when filed}$$

where dₛ₀ and G represent the nominal responses, and Δdₛ and ΔG represent perturbations from the nominal. The error after control, eₛ can be expressed in the perturbed case as

$${e}_{s} = {e}_{s 0} + Δ {e}_{s} \text{?} \qquad ( 3.3 )$$

$$\text{?} \text{indicates text missing or illegible when filed}$$

which can be written in terms of the summation of the components due to the disturbance and the control sources as

$${e}_{s} = {d}_{s} + Gu \text{?} \qquad ( 3.4 )$$

$$\text{?} \text{indicates text missing or illegible when filed}$$

and by substituting Equation 3.1 and 3.2 can be expressed as

$${e}_{s} = {d}_{s 0} + Δ {d}_{s} + ( {G}_{0} + Δ G ) u \qquad ( 3.5 )$$

The cost function in the context of acoustic cloaking is defined as the sum of the squared scattered acoustic pressures after control, which is given as

$$J = {e}_{s}^{H} {e}_{s} . \qquad ( 3.6 )$$

By combining Equations 3.4 and 3.6, the cost function can be expressed as

$$J = {( {d}_{s} + Gu )}^{H} ( {d}_{s} + Gu ) . \qquad ( 3.7 )$$

By expanding and differentiating Equation 3.7 with respect to the real and imaginary parts of the vector of control filter coefficients, and setting the real and imaginary parts to 0, the robust set of optimal control source strengths, uₒₚₜ, can be calculated as

$${u}_{opt} = - {[ {G}^{H} G ]}^{- 1} + {G}^{H} {d}_{s} \qquad ( 3.8 )$$

which, by substituting in Equations 3.1 and 3.2, can be expressed as

$$( 3.9 )$$

$${u}_{opt} = - {[ {G}_{0}^{H} {G}_{0} + Δ {G}^{H} Δ G + {G}_{0}^{H} Δ G + Δ {G}^{H} {G}_{0} ]}^{- 1} {G}_{0}^{H} {d}_{s 0} + Δ {G}^{H} {d}_{s 0} + {G}_{0}^{H} {d}_{s} + {G}^{H} Δ {d}_{s} .$$

In the special case where Δdₛ and ΔG are random and uncorrelated with one another, it can be shown that

$$E [ {G}_{0}^{H} Δ G ] = 0 , \qquad ( 3.1 )$$

$$E [ Δ {G}^{H} {G}_{0} ] = 0 , \qquad ( 3.11 )$$

$$E [ Δ {G}^{H} {d}_{s 0} ] = 0 , \qquad ( 3.12 )$$

$$E [ {G}_{0}^{H} Δ {d}_{s} ] = 0 , \qquad ( 3.13 )$$

$$E [ Δ {G}^{H} Δ {d}_{s} ] = 0 , \qquad ( 3.14 )$$

$$E [ Δ {G}^{H} Δ G ] \approx β I , \qquad ( 3.15 )$$

and therefore Equation 3.9 reduces to the regularised solution for the nominal system

$${u}_{opt} = - {[ {G}_{0}^{H} {G}_{0} + β I ]}^{- 1} {G}_{0}^{H} {d}_{s 0} . \qquad ( 3.16 )$$

For the avoidance of doubt, in Equation 3.16, uₒₚₜ is the optimal set of control source strengths of the control source arrangement, G₀ is the nominal matrix of plant responses, I is the identity matrix, dₛ₀ is the nominal scattered acoustic pressure (or “scattered disturbance signal”), and β is the regularisation parameter.

Finally, a suitable regularisation parameter β is to be determined. This is done by the processor 220 selecting a value of the regularisation parameter that provides a suitable level of attenuation of the acoustic signal for an expected or desired level of perturbation of the object 350, based on a relationship between a level of attenuation of the acoustic signal when the control source arrangement 370 is operated and a value of the regularisation parameter.

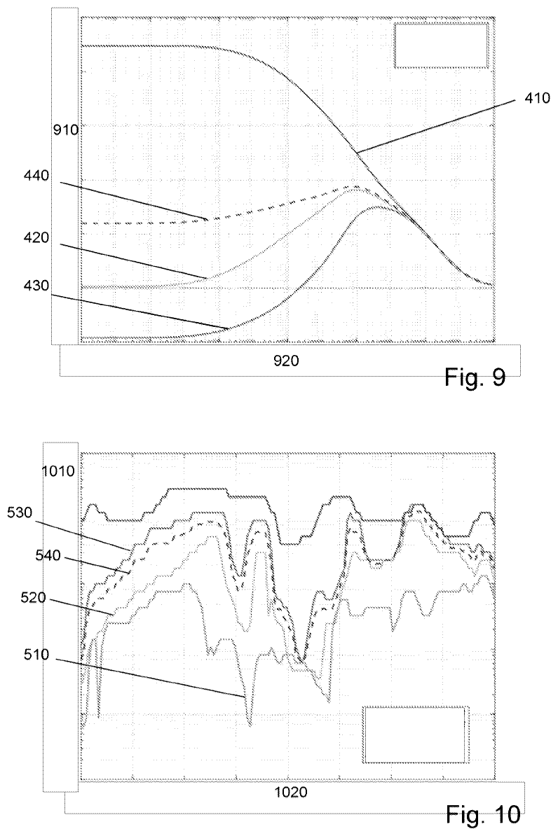

Referring to FIG. 9, plots of the relationship between a level of control/attenuation of the acoustic signal when the control source arrangement 370 is operated and a value of the regularisation parameter is shown. Level of control/attenuation of the acoustic signal (y-axis—910) is plotted against a range of test regularisation parameters (x-axis—920). A first relationship wherein the object is in a first condition is indicated at 410. A second relationship when the object is in a second condition is indicated at 420. A third relationship wherein the object is in a third condition is indicated at 430. An average of the three relationships is indicated at 440. In this exemplary embodiment, the first condition is where the object is unperturbed from a nominal position, the second condition is where the object is displaced from the nominal position by 0.1 m in a first direction, and the third condition is where the object is displaced from the nominal position by 0.2 m in the first direction.

As can be seen in each of the second, third and average relationship shown in FIG. 9, the level of attenuation of the acoustic signal steadily increases to a peak value as the regularisation parameter value increases, before a rapidly drop-off in level of attenuation as the regularisation parameter value is increased further. In this exemplary embodiment, it is expected that the object 350 will undergo a change in condition by being displaced from a nominal position by 0.2 m in the first direction. So, in this case, the regularisation parameter is selected as the value corresponding to the peak level of attenuation in the average of the three relationships. This determined value of the regularisation parameter is the value that will enable the active acoustic control system 300 to maintain optimal performance even if the object 350 is displaced or perturbed from the nominal position.

It will be understood by the skilled person that a similar method can be followed to determine a regularisation parameter when the object 350 changes in size, or is influenced by temperature/pressure, or where the system 300 is affected by variations in electromagnetic noise, as mentioned above.

In an exemplary embodiment, a single regularisation parameter is determined and is used to control the acoustic signal, irrespective of the frequency of the acoustic signal. That is, the regularisation parameter is frequency independent.

However, in another exemplary embodiment, regularisation parameters can be determined that are frequency dependent. That is, a first regularisation parameter may be determined as optimal for a first frequency band or range of frequencies. Another regularisation parameter may be determined as optimal for a different frequency band or range of frequencies. By determining frequency dependent regularisation parameters, the optimal regularisation parameter can be used in the active acoustic control system 300 for the frequency of the acoustic signal, and of the scattered acoustic pressure component, that it is desired to control. In other words, the processor 220 is configured to determine a set of regularisation parameter values, each value of the set of regularisation parameters being determined to correspond to a peak level of control of the scattered acoustic pressure component of the acoustic signal across at least a subrange of a frequency range.

Referring to FIG. 10, plots of the value of regularisation parameter which achieves optimal acoustic cloaking performance (determined as described above) vs frequency are shown. The optimal regularisation parameter (y-axis—1010) is plotted against the frequency of the acoustic signal (x-axis—1020). Similarly to the frequency independent determination described above, a first relationship wherein the object is in a first condition is indicated at 510, a second relationship when the object is in a second condition is indicated at 520, and a third relationship wherein the object is in a third condition is indicated at 530. An average of the three relationships is indicated at 540. For a frequency or frequency band of the acoustic signal that it is desired to control (which may be the frequency of the acoustic signal detected), a suitable regularisation parameter can be determined by reference to the plots, and in particular to the average plot 540.

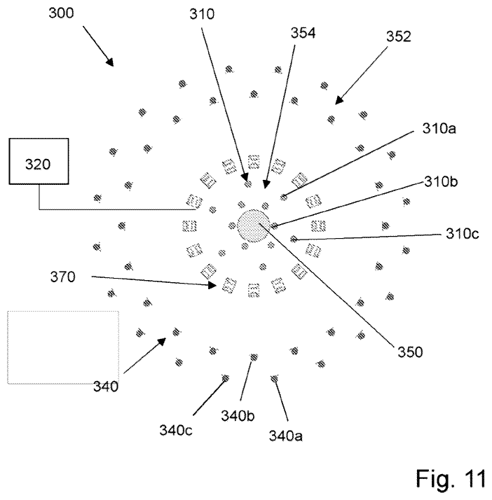

Referring to FIG. 11, the active acoustic control system 300 is shown. The system 300 comprises a first sensor arrangement 310 arranged to sense an acoustic signal in the region of an object 350. The acoustic signal comprises a scattered acoustic pressure component and a total acoustic pressure, the first sensor arrangement 310 being arranged to sense the total acoustic pressure of the acoustic signal. The system 300 further comprises a processor 320 configured to apply a first filter to filter the total acoustic pressure and provide a filtered output signal. The processor 320 is further configured to estimate the scattered acoustic pressure component based on the filtered output signal from the first filter. The system 300 further comprises a control source arrangement 370 operable to control the scattered acoustic pressure component based on the estimation of the processor 320 and a regularisation parameter determined based on a relationship between a level of control of the scattered acoustic pressure component of the acoustic signal when controlled using the control source arrangement 370 of the active acoustic control system using a set of test regularisation parameters.

The processor 320 may be configured to control the control source arrangement 370 to control the scattered acoustic pressure component based on the estimation of the processor 320 and the regularisation parameter.

Importantly, and as stated above, the control source arrangement 370 is operable to control the scattered acoustic pressure component based on, which includes “using”, the regularisation parameter. In an exemplary embodiment, a high value of the regularisation parameter will enable the system 300 to control acoustic signals despite changes in condition of the system 300 or object 350. That is, a high value of the regularisation parameter ensures robustness. However, in such cases the level of control of the scattered acoustic pressure component system 300 will be lower than a maximum level achievable by the system 300. In contrast, a low value of the regularisation parameter will enable the system 300 to perform well in an “ideal” case (e.g., at nominal position or size), which may be a position in which the system 300 is calibrated. However, in such cases the performance of the system 300 will depreciate when uncertainties are introduced. Determination of the regularisation parameter may be a trade-off between, or optimisation of, robustness and level of control of the scattered acoustic pressure component. Determination of a suitable regularisation parameter value for the use case can be performed as described above. The benefits explained above are obtained by the control of the control source arrangement 370 using a regularisation parameter.

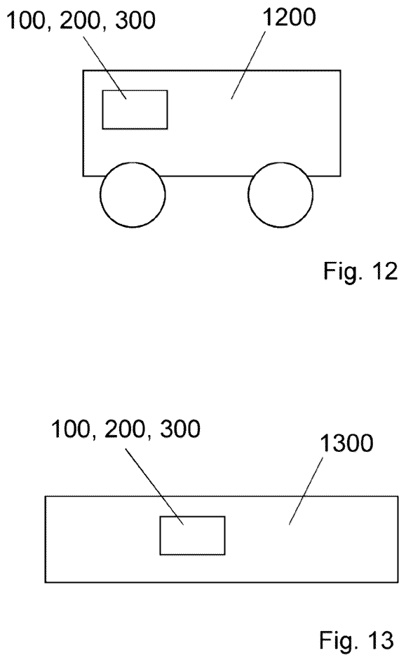

Referring to FIG. 12, a vehicle 1200 is shown. The vehicle 1200 may be a land-based vehicle, aircraft, watercraft, or sub-surface vehicle. The vehicle 1200 comprises an active acoustic control system 100, 300 and/or a regularisation parameter determination system 200.

Referring to FIG. 13, a structure 1300 is shown. The structure 1300 may be infrastructure, a building, or the like. The structure 1300 comprises an active acoustic control system 100, 300 and/or a regularisation parameter determination system 200.

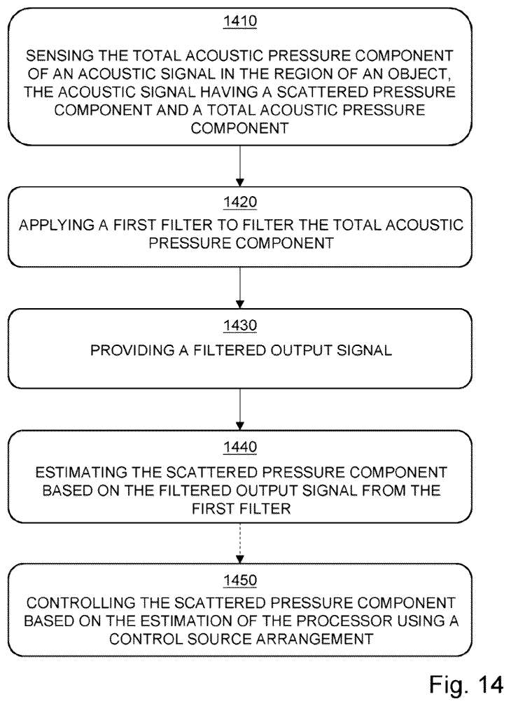

Referring to FIG. 14, a method of active acoustic control is shown. Step 1410 comprises sensing the total acoustic pressure of an acoustic signal in the region of an object, the acoustic signal having a scattered acoustic pressure component and a total acoustic pressure. Step 1420 comprises applying a first filter to filter the total acoustic pressure. Step 1430 comprises providing a filtered output signal. Step 1440 comprises estimating the scattered acoustic pressure component based on the filtered output signal from the first filter. Optional step 1450 comprises controlling the scattered acoustic pressure component based on the estimation of the processor using a control source arrangement.

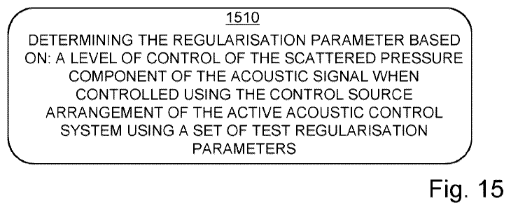

Referring to FIG. 15, a method of determining a regularisation parameter for use in operation of an active acoustic control system 300 is shown. Step 1510 comprises determining the regularisation parameter based on: a level of control of the scattered acoustic pressure component of the acoustic signal when controlled using the control source arrangement of the active acoustic control system 300 using a set of test regularisation parameters.

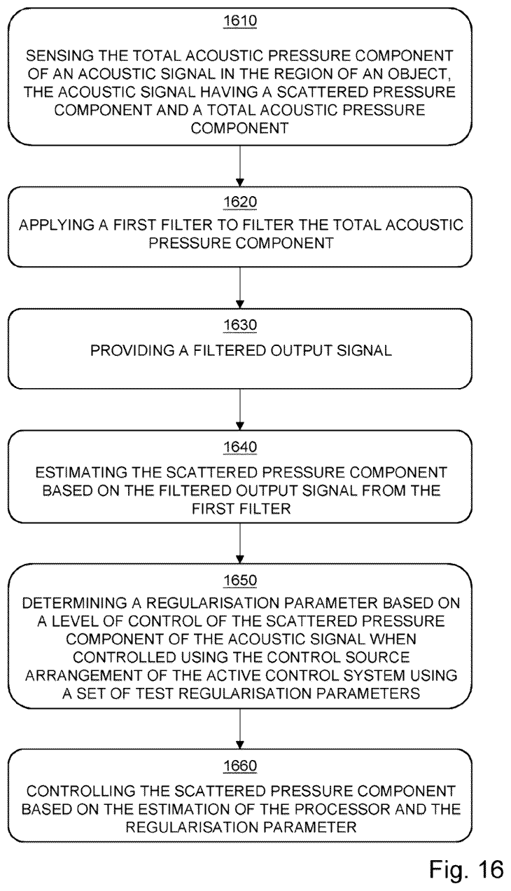

Referring to FIG. 16, a method of active acoustic control is shown. Step 1610 comprises sensing the total acoustic pressure of an acoustic signal in the region of an object, the acoustic signal having a scattered acoustic pressure component and a total acoustic pressure. Step 1620 comprises applying a first filter to filter the total acoustic pressure. Step 1630 comprises providing a filtered output signal. Step 1640 comprises estimating the scattered acoustic pressure component based on the filtered output signal from the first filter. Step 1650 comprises determining a regularisation parameter based on a level of control of the scattered acoustic pressure component of the acoustic signal when controlled using the control source arrangement of the active control system using a set of test regularisation parameters. Step 1660 comprises controlling the scattered acoustic pressure component based on the estimation of the processor and the regularisation parameter.

Although a preferred embodiment has been shown and described, it will be appreciated by those skilled in the art that various changes and modifications might be made without departing from the scope of the invention, as defined in the appended claims and as described above.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A regularisation parameter determination system for determining a regularisation parameter for use in operation of an active acoustic control system, the active acoustic control system including a first sensor arrangement arranged to sense an acoustic signal in the region of an object, the acoustic signal having a scattered acoustic pressure component and a total acoustic pressure, the first sensor arrangement being arranged to sense the total acoustic pressure of the acoustic signal, the active acoustic control system further including a processor configured: to (a) apply a first filter to filter the total acoustic pressure and provide a filtered output signal, and (b) estimate the scattered acoustic pressure component based on the filtered output signal from the first filter, the active acoustic control system further including a control source arrangement operable to control the scattered acoustic pressure component based on the estimation of the processor and the regularisation parameter, the regularisation parameter determination system comprising:
a processor configured to determine the regularisation parameter based on a level of control of the scattered acoustic pressure component of the acoustic signal when the acoustic signal is controlled using the control source arrangement of the active acoustic control system using a set of test regularisation parameters.

2. The regularisation parameter determination system according to claim 1, wherein the processor is configured to determine the regularisation parameter based on an optimisation of a relationship between:
the level of control of the scattered acoustic pressure component of the acoustic signal when the acoustic signal controlled using the control source arrangement of the active acoustic control system using the set of test regularisation parameters; and
a condition of the active acoustic control system and/or the object.

3. (canceled)

4. The regularisation parameter determination system according to claim 1, wherein the set of test regularisation parameters comprises a range of test regularisation parameters.

5. The regularisation parameter determination system according to claim 1, wherein the control source arrangement is operable according to
$${u}_{opt} = - {[ {G}_{0}^{H} {G}_{0} + β I ]}^{- 1} {G}_{0}^{H} {d}_{s 0}$$
where uₒₚₜ is an optimal set of control source strengths of the control source arrangement, G₀ is a nominal matrix of plant responses, I is an identity matrix, dₛ₀ is a nominal scattered acoustic pressure, and β is the regularisation parameter.

6. The regularisation parameter determination system according to claim 1, wherein the regularisation parameter is frequency independent.

7. The regularisation parameter determination system according to claim 6, wherein the value of the regularisation parameter is determined to correspond to a peak level of control of the scattered acoustic pressure component of the acoustic signal across a frequency range.

8. The regularisation parameter determination system according to claim 1, wherein the regularisation parameter is frequency dependent.

9. The regularisation parameter determination system according to claim 8, wherein a set of regularisation parameter values are determined, each value of the set of regularisation parameters being determined to correspond to a peak level of control of the scattered acoustic pressure component of the acoustic signal across at least a subrange of a frequency range.

10. An active acoustic control system comprising:
a first sensor arrangement arranged to sense an acoustic signal in the region of an object, the acoustic signal having a scattered acoustic pressure component and a total acoustic pressure, the first sensor arrangement being arranged to sense the total acoustic pressure of the acoustic signal;
a processor configured to (a) apply a first filter to filter the total acoustic pressure and provide a filtered output signal, and (b) estimate the scattered acoustic pressure component based on the filtered output signal from the first filter; and
a control source arrangement operable to control the scattered acoustic pressure component based on the estimation of the processor and a regularisation parameter determined based on a level of control of the scattered acoustic pressure component of the acoustic signal when controlled using the control source arrangement of the active acoustic control system using a set of test regularisation parameters.

11. A vehicle or structure comprising the regularisation parameter determination system according to claim 1.

12. (canceled)

13. A method of active acoustic control comprising:
sensing the total acoustic pressure of an acoustic signal in the region of an object, the acoustic signal having a scattered acoustic pressure component and a total acoustic pressure;
applying a first filter to filter the total acoustic pressure;
providing a filtered output signal;
estimating the scattered acoustic pressure component based on the filtered output signal from the first filter;
determining a regularisation parameter based on a level of control of the scattered acoustic pressure component of the acoustic signal when controlled using the control source arrangement of the active acoustic control system using a set of test regularisation parameters; and
controlling the scattered acoustic pressure component based on the estimation of the processor and the regularisation parameter.

14. The method according to claim 13, comprising determining the regularisation parameter based on an optimisation of a relationship between:
the level of control of the scattered acoustic pressure component of the acoustic signal when the acoustic signal controlled using the control source arrangement of the active acoustic control system using the set of test regularisation parameters; and
a condition of the active acoustic control system and/or the object.

15. The method according to claim 13, further comprising:
based on a plurality of relationships between a level of attenuation and a value of the regularisation parameter, each relationship being for one of a plurality of conditions of the object, selecting a value of the regularisation parameter corresponding to a peak level of attenuation in an average of the relationships.

16. The method according to claim 14, further comprising:
based on a plurality of relationships between a level of attenuation and a value of the regularisation parameter, each relationship being for one of a plurality of conditions of the object, selecting a value of the regularisation parameter corresponding to a peak level of attenuation in an average of the relationships.

17. The active acoustic control system according to claim 10, wherein the processor is configured to determine the regularisation parameter based on a relationship between:
the level of control of the scattered acoustic pressure component of the acoustic signal when controlled using the control source arrangement of the active acoustic control system using a set of test regularisation parameters; and
a value of the regularisation parameter.

18. The active acoustic control system according to claim 10, wherein the regularisation parameter is frequency independent.

19. The active acoustic control system according to claim 18, wherein the value of the regularisation parameter is determined to correspond to a peak level of control of the scattered acoustic pressure component of the acoustic signal across a frequency range.

20. The active acoustic control system according to claim 10, wherein the regularisation parameter is frequency dependent.

21. The active acoustic control system according to claim 20, wherein a set of regularisation parameter values are determined, each value of the set of regularisation parameters being determined to correspond to a peak level of control of the scattered acoustic pressure component of the acoustic signal across at least a subrange of a frequency range.

22. A vehicle or structure comprising the active acoustic control system according to claim 10.
